(19) United States
(12) Patent Application Publication
(10) Pub. No.: US 2010/0002679 A1
(43) Pub. Date: Jan. 7, 2010

(54) METHOD AND SYSTEM FOR SYNCHRONIZING A LOCAL CLOCK IN A WIRELESS DEVICE TO A HOST CLOCK IN A WIRELESS HOST

(75) Inventors: Yifeng Zhang, San Jose, CA (US); Robbert Emery, San Jose, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP BV, Eindhoven (NL)

(21) Appl. No.: 12/441,506

(22) PCT Filed: Sep. 19, 2006
(86) PCT No.: PCT/IB2006/053382

§ 371 Date: Sep. 4, 2009

(51) Int. Cl. H04J 3/06

(52) U.S. Cl. 370/350

(57) ABSTRACT

A wireless device (400) receives a beacon frame. Using the carrier frequency information included in the beacon frame, a frequency offset value between the wireless device (400) and the wireless host (500) is determined. Based on the frequency offset value, a clock drift value between the host clock (504) in the wireless host (500) and the local clock (406) in the wireless device (400) is determined. The wireless device (400) is then powered up in preparation for receiving a subsequent beacon frame based on the clock drift value between the host clock (504) in the wireless host (500) and the local clock (406) in the wireless device (400).

In a wireless communication system, a wireless host periodically transmits a beacon frame over one or more radio frequency (RF) channels. Each beacon frame provides information about the host, including a service set identifier to identify a specific wireless network, a carrier frequency, and the beacon interval, which specifies the amount of time between beacon transmissions. A wireless device that receives a beacon frame can use the information in the beacon frame to determine whether to associate with the host.

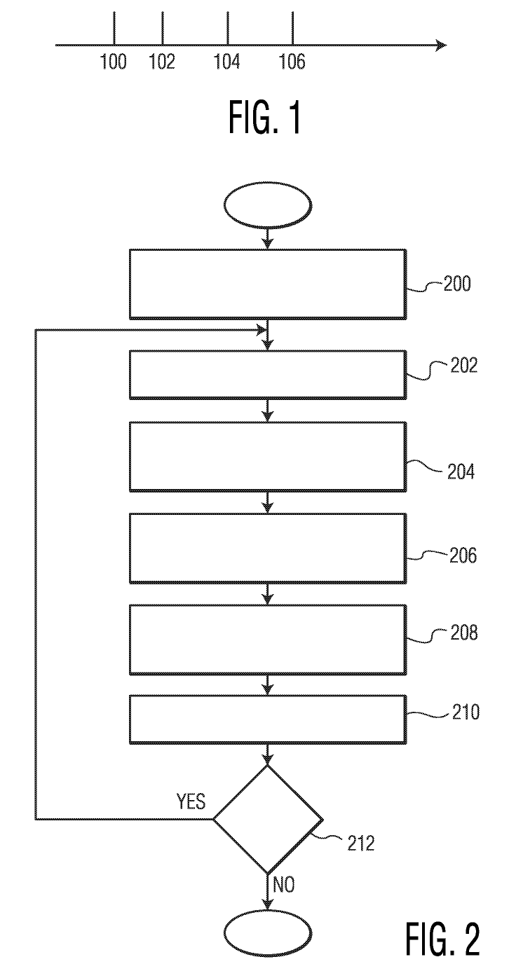

Wireless devices typically operate in several different modes. One such mode is known as standby mode, where a wireless device does not transmit or receive any data frames. The wireless device does, however, receive beacon frames when in standby mode. To receive a beacon frame in standby mode, a wireless device may need to power up from a low power state, such as a sleep state, in order to receive the beacon frame. FIG. 1 is a conceptual timing diagram in accordance with the prior art. At time 100 the wireless device is in a lower power state. The wireless device powers up to a higher power state, such as full power, at time 102. The wireless device powers up in preparation for receiving a beacon frame. The wireless device then receives a beacon frame at time 104 and returns to a lower power state at time 106. The device repeats powering up, receiving a beacon frame, and powering down based on the beacon interval of the host.

A wireless device may power up prior to the host transmitting the beacon frame based on a predetermined maximum clock drift between the wireless host and device or on a predetermined number of clock cycles difference between the host and the device. This ensures the wireless device has sufficient time to reach the power level needed to receive the beacon frame. Unfortunately the wireless device may power up much earlier than necessary, causing the wireless device to needless consume power while waiting to receive the beacon frame.

In accordance with the invention, a method and system for synchronizing a local clock in a wireless device to a host clock in a wireless host are provided. A beacon frame is received by a wireless device. Using the carrier frequency information included in the beacon frame, a frequency offset value between the wireless device and the wireless host is determined. Based on the frequency offset value, a clock drift value between the host clock and the local clock in the wireless device is determined. The wireless device is then powered up in preparation for receiving a subsequent beacon frame based on the clock drift value between the host clock and the local clock in the wireless device.

FIG. 1 is a conceptual timing diagram in accordance with the prior art;

FIG. 2 is a flowchart of a method for synchronizing a local clock in a wireless device to a host clock in a wireless host in an embodiment in accordance with the invention;

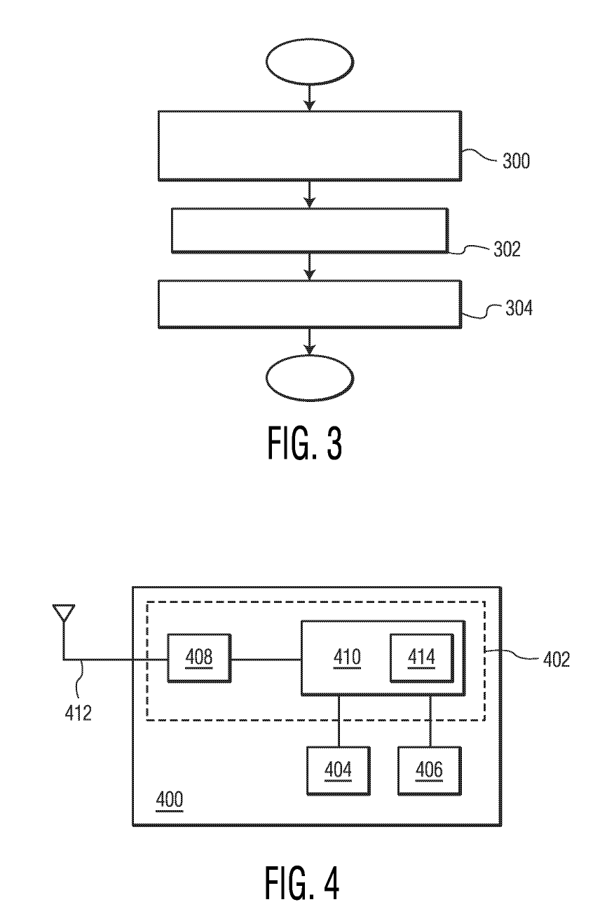

FIG. 3 is a flowchart of an exemplary method for calibrating a local clock in a wireless device to a master clock in a wireless device as shown in block 200 of FIG. 2;

FIG. 4 is a block diagram of a wireless device in an embodiment in accordance with the invention; and

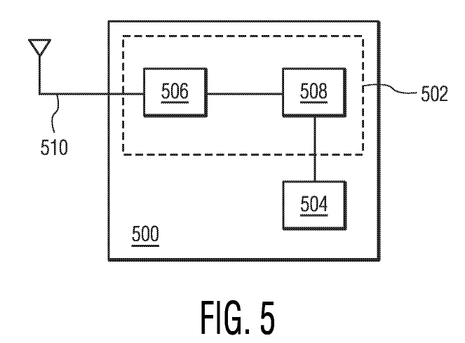

FIG. 5 is a block diagram of a wireless host in an embodiment in accordance with the prior art.

The following description is presented to enable one skilled in the art to make and use embodiments in accordance with the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

With reference to the figures and in particular with reference to FIG. 2, there is shown a flowchart of a method for synchronizing a local clock in a wireless device to a host clock in a wireless host in an embodiment in accordance with the invention. Initially a local clock in a wireless device is synchronized to a master clock within the device, as shown in block 200. FIG. 3 is a flowchart of an exemplary method for calibrating a local clock in a wireless device to a master clock in a wireless device as shown in block 200 of FIG. 2. Initially the local clock runs for a predetermined number of clock cycles, as shown in block 300. During this time the clock cycles of the master clock in the device are counted and a difference value in clock cycles is then calculated by subtracting the predetermined clock cycles of the local clock from the counted clock cycles of the master clock. These steps are shown in blocks 304, 306. Thus, the calibration process of FIG. 3 calculates a local drift value between the local clock and the master clock.

Returning again to FIG. 2, a beacon frame is received from a host at block 202. As discussed earlier, a beacon frame includes a carrier frequency for the host. Using the carrier frequency, a frequency offset between the host and the wireless device is determined at block 204. The frequency offset provides a parts per million (ppm) value regarding the accuracy of the clock. The ppm value is then used to determine a difference value between a number of clock cycles of the host clock in the host and a number of clock cycles of the local clock in the device. This step is illustrated in block 206.

A clock drift value for a beacon period is then determined, as shown in block 208. The clock drift value determines the drift or difference between the host clock in the host and the local clock in the device. The clock drift value is then stored at block 210.

Next, at block 212, a determination is made as to whether the process should repeat. If so, the method returns to block 202 and repeats. The process is repeated periodically in the embodiment of FIG. 2. For example, in one embodiment in accordance with the invention, the method repeats at fixed intervals of time. The process may repeat at variable intervals of time in other embodiment in accordance with the invention.

When the wireless device is to be powered up to receive a beacon frame, the amount of time the device is powered up prior to receiving the beacon frame is based on the clock drift value. Other embodiments in accordance with the invention are not limited to the blocks shown in FIG. 2 and their order. Embodiments in accordance with the invention may include additional blocks or may structure the method differently than shown in FIG. 2. For example, the process may return to block 200 instead of block 202 in other embodiments in accordance with the invention.

FIG. 4 is a block diagram of a wireless device in an embodiment in accordance with the invention. Wireless device 400 includes transceiver section 402, master clock 404, and local clock 406. Transceiver section 402 includes RF section 408 and baseband section 410. Only the elements needed to describe an embodiment of the invention are shown in FIG. 4. Wireless device 400 may include other elements in other embodiments in accordance with the invention.

RF section 408 and baseband section 410 include both a transmit path and a receive path to allow wireless device 400 to transmit and receive data using antenna 412. Although only one antenna is shown in FIG. 4, wireless device 400 may include multiple antennas in other embodiments in accordance with the invention. The transmit path in RF section 408 and baseband section 410 may include filters, one or more conversion stages, such as, for example, an intermediate frequency (IF) conversion stage, digital-to-analog converters, encoders, signal modulators, transmit amplifiers, impedance matching circuits to couple the transmit signal to the antenna, and other suitable circuitry to convert a baseband signal into a RF wireless signal.

The receive path in RF section 408 and baseband section 410 may include filters, amplifiers, a down conversion stage, decoders, demodulators, analog-to-digital converters, and other suitable circuitry to translate the wireless signal into a baseband signal. Wireless device 400 transmits and receives data pursuant to one or more wireless standards. For example, wireless device 400 operates pursuant to a Wireless Local Area Network (WLAN) standard in an embodiment in accordance with the invention. In another embodiment in accordance with the invention, wireless device 400 operates pursuant to an Ultra-Wide Band (UWB) standard. And in other embodiments in accordance with the invention, wireless device 400 may operate with other types of wireless standards, including, but not limited to, a Wireless Personal Area Network (WPLAN) standard.

RF section 408 and baseband section 410 are implemented as integrated circuits with baseband section 410 including processing unit 414 in an embodiment in accordance with the invention. Processing unit 414 is implemented separately from baseband section 410 in another embodiment in accordance with the invention. And in yet another embodiment in accordance with the invention, processing unit 414 is implemented separately from transceiver section 402.

Processing unit 414 calibrates local clock 406 with master clock 404 in an embodiment in accordance with the invention. An exemplary calibration method is illustrated and described in conjunction with FIG. 3. Beacon frames are received by antenna 412 and processed by RF section 408 and baseband section 410. Blocks 204-208 shown in FIG. 2 are performed by processing unit 414, which is implemented as a media access controller (MAC) in an embodiment in accordance with the invention. Multiple processing units may perform some or all of the blocks shown in FIG. 2 in other embodiments in accordance with the invention.

Referring to FIG. 5, there is shown a block diagram of a wireless host in an embodiment in accordance with the prior art. Wireless host 500 includes transceiver section 502 and host clock 504. Transceiver section 502 includes RF section 506 and baseband section 508. Only the elements needed to describe an embodiment of the invention are shown in FIG. 5. Wireless host 500 may include other elements in other embodiments in accordance with the invention.

RF section 506 and baseband section 508 include a transmit path and a receive path to allow wireless host 500 to transmit and receive data using antenna 510. The transmit and receive paths include components similar to those described in conjunction with FIG. 4. Transceiver section 502 transmits beacon frames over one or more RF channels using antenna 510. As discussed earlier, a beacon frame includes a carrier frequency for wireless host 500. A wireless device uses the carrier frequency to determine a clock drift value during a beacon period. The clock drift value is then used to synchronize the local clock in the wireless device with the host clock in the wireless host.

Synchronization of a local clock in a wireless device to a host clock may be performed any time the wireless device is powered up or down in an embodiment in accordance with the invention. For example, the local clock is synchronized to the host clock when the device is powered up from a standby mode in an embodiment in accordance with the invention. In another embodiment in accordance with the invention, the local clock in the device is synchronized to the host clock when the device is first turned on and then when the device enters or exits a standby mode.

1. A wireless device, comprising: a local clock; and a processing unit operable to determine for a beacon period a first clock drift value between the local clock and a host clock using a calculated frequency offset.

2. The wireless device of claim 1, further comprising a master clock.

3. The wireless device of claim 2, wherein the processing unit is operable to determine a second clock drift value between the master clock and the local clock in the wireless device.

4. The wireless device of claim 1, wherein the processing unit comprises a baseband integrated circuit device.

5. The wireless device of claim 4, wherein the baseband integrated circuit device comprises a media access controller.

6. A method for synchronizing a local clock in a wireless device to a host clock in a wireless host, comprising: determining a frequency offset value between the wireless host and the wireless device; and determining for a beacon period a clock drift value between the local clock in wireless device and the host clock in the wireless host using the frequency offset value.

7. The method of claim 6, further comprising receiving a beacon frame prior to determining a frequency offset value between the wireless host and the wireless device.

8. The method of claim 7, further comprising calibrating the local clock in the wireless device to a master clock in the wireless device prior to determining a frequency offset value between the wireless host and the wireless device.

9. The method of claim 8, wherein calibrating the local clock in the wireless device to a master clock in the wireless device comprises: operating the local clock for a predetermined number of clock cycles; counting a number of clock cycles of the master clock while the local clock operates for the predetermined number of clock cycles; and determining a clock drift value between the local clock and the master clock in the wireless device.

10. The method of claim 6, further comprising powering up the wireless device in preparation of receiving a subsequent beacon frame based on the clock drift value between the local clock in wireless device and the host clock in the wireless host.

11. The method of claim 6, further comprising periodically repeating: determining a frequency offset value between the wireless host and the wireless device; and determining for a beacon period a clock drift value between the local clock in wireless device and the host clock in the wireless host using the frequency offset value.

12. The method of claim 11, wherein determining a frequency offset value between the wireless host and the wireless device and determining for a beacon period a clock drift value between the local clock in the wireless device and the host clock in the wireless host using the frequency offset value are repeated at fixed time intervals.

13. The method of claim 11, wherein determining a frequency offset value between the wireless host and the wireless device and determining for a beacon period a clock drift value between the local clock in the wireless device and the host clock in the wireless host using the frequency offset value are repeated at variable time intervals.
